(19) United States
(12) Patent Application Publication
(10) Pub. No.: US 2026/0286778 A1
(43) Pub. Date: Sep. 24, 2026

(54) SPLICED TREAD FOR LADDER AND FOLDING LADDER

(71) Applicant: Luhao LENG, Xiamen (CN)

(72) Inventor: Luhao LENG, Xiamen (CN)

(21) Appl. No.: 19/632,691

(22) Filed: Mar. 30, 2026

Related U.S. Application Data
(63) Continuation of application No. PCT/CN2026/083726, filed on Mar. 16, 2026.

(30) Foreign Application Priority Data
Mar. 18, 2025 (CN) 202520471044.6

(51) Int. Cl. E06C 7/08; E06C 1/387; E06C 1/393

(52) U.S. Cl. CPC E06C 7/08; E06C 1/387; E06C 1/393

(57) ABSTRACT

A spliced tread for a ladder includes at least two tread units. A top surface of the at l east two tread units extends along a thickness direction at one end in a width direction to form a first connection portion, and extends along the thickness direction at a second end to form a second connection portion. The first connection portion of one of the at least two tread units and the second connection portion of an adjacent one of the at least two tread units are connected to each other, so that the at least two tread units are spliced along the width direction to form the spliced tread for the ladder.

### RELATED APPLICATIONS

This application is a continuation of International Patent Application PCT/CN2026/083726, filed on Mar. 16, 2026, which claims priority to Chinese patent application number 202520471044.6, filed on Mar. 18, 2025. International Patent Application PCT/CN2026/083726 and Chinese patent application number 202520471044.6 are incorporated herein by reference.

### FIELD OF THE DISCLOSURE

The present disclosure relates to ladder tools, and more particularly, to a spliced tread for a ladder and a folding ladder.

### BACKGROUND OF THE DISCLOSURE

Traditional folding ladders mostly use a fixed tread design, and a tread width and an installation position are predetermined during a manufacturing stage, leading to a prominent issue of single functionality in ladder tools. In the existing techniques, if users need to adapt to different working heights or span requirements, they often have to purchase ladder tools of various specifications, which not only increases economic costs but also causes waste of storage space.

The tread width of conventional folding ladders cannot be adaptively adjusted according to limb length of the user or characteristics of a working scenario. When it is necessary to set up a ladder tool in a narrow space, fixed-width treads often interfere with surrounding obstacles, preventing the ladder tools from being effectively deployed.

### BRIEF SUMMARY OF THE DISCLOSURE

In order to solve the above technical problems, the present disclosure provides a spliced tread for a ladder comprising at least two tread units. The at least two tread units comprises at least one of a first tread unit or a second tread unit. One end of a top surface of the first tread unit in a width direction of the spliced tread extends in a thickness direction of the spliced tread to form a first connection portion to define a side of the first tread unit, and a corresponding end of the second tread unit extends in the thickness direction of the spliced tread to form a second connection portion to define a side of the second tread unit.

The first connection portion of the first tread unit and the second connection portion of the second tread unit are connected to each other, so that the at least two tread units are spliced in the width direction of the spliced tread to form the spliced tread for the ladder.

In some embodiments, the first connection portion comprises at least two first riveting portions protruding in a thickness direction of the first connection portion and spaced apart from each other in a length direction of the first connection portion, and the second connection portion comprises at least two second riveting portions recessed in a thickness direction of the second connection portion and spaced apart from each other in a length direction of the second connection portion. The at least two first riveting portions and the at least two second riveting portions are connected by pressure riveting.

In some embodiments, the first connection portion comprises at least two riveting holes spaced apart from each other in the length direction of the first connection portion, and the second connection portion comprises at least two riveting holes spaced apart from each other in the length direction of the second connection portion. The at least two riveting holes of the first connection portion and the at least two riveting holes of the second connection portion are riveted together by rivets.

In some embodiments, the first connection portion comprises at least two bolt holes spaced apart from each other in the length direction of the first connection portion, and the second connection portion comprises at least two bolt holes spaced apart from each other in the length direction of the second connection portion. Bolts are configured to pass through the at least two bolt holes of the first connection portion and the at least two bolt holes of the second connection portion to be connected to nuts.

In some embodiments, a top of the second connection portion is bent downward towards the first connection portion of an adjacent one of the at least two tread units to form a U-shaped hook, and the first connection portion extends upward to form a U-shaped limiting portion extending upward. The U-shaped limiting portion extends to an interior of the U-shaped hook to be interlocked with the U-shaped hook.

In some embodiments, the bottom of the second connection portion is bent upward to form a U-shaped supporting seat, and the U-shaped supporting seat limits movement of a bottom end of the first connection portion.

In some embodiments, the spliced tread of the ladder further comprises a U-shaped packaging member. The U-shaped packaging member comprises an upper edge portion and a lower edge portion opposite to the upper edge portion, as well as a side packaging portion connecting the upper edge portion and the lower edge portion.

In some embodiments, two ends of the upper edge portion comprise riveting holes, and corresponding positions of top surfaces of the at least two tread units corresponding to the riveting holes on the upper edge portion comprises riveting holes. The riveting holes of the upper edge portion and the riveting holes on the top surfaces of the at least two tread units are riveted together with second rivets.

In some embodiments, a bottom of the second connection portion extends outward to form an extension portion, and two ends of the extension portion in a length direction of the extension portion comprise riveting holes. The lower edge portion comprises riveting holes corresponding to riveting holes of the extension portion in a one-to-one correspondence, and the riveting holes of the lower edge portion and the riveting holes of the extension portion are riveted together with third rivets.

The present disclosure further provides a folding ladder, and the folding ladder comprises a front ladder frame, a rear ladder frame, and a plurality of the spliced treads. Two rods of the front ladder frame are pivotally connected to two rods of the rear ladder frame, and the plurality of the spliced treads are divided into a top tread and a plurality of sub-treads arranged sequentially along a height direction of the folding ladder.

In some embodiments, a number of the at least two tread units of the top tread is greater than a number of the at least two tread units of the plurality of sub-treads, and front ends of U-shaped packaging members of the plurality of the spliced treads comprises a first pivoting member. Front ends of the top tread and the plurality of sub-treads are pivotally connected to the two rods of the front ladder frame through the first pivoting member.

In some embodiments, a middle portion of the top tread comprises a second pivoting member, and rear end portions of the plurality of sub-treads comprise additional second pivoting members. A side connecting rod is provided, and the top tread is pivotally connected to the side connecting rod through the second pivoting member. The plurality of sub-treads are pivotally connected to the side connecting rod through the additional second pivoting members.

In some embodiments, the folding ladder further comprises a supporting rod. One end of the supporting rod is pivotally connected to a middle portion of the side connecting rod, and a second end of the supporting rod is pivotally connected to a corresponding one of the two rods of the rear ladder frame.

Compared with the existing techniques, the spliced tread of the present disclosure comprises the at least two tread units, which extend downward to form at least one of the first connection portion or the second connection portion. The first connection portion and the second connection portion of two adjacent tread units are connected to each other, thereby being spliced to form the spliced tread, allowing for adaptability adjustments in tread width based on specific user scenarios and physical characteristics of the user. At the same time, the tread of the present disclosure is convenient for transportation and storage.

### BRIEF DESCRIPTION OF THE DRAWINGS

FIG. 1 is a perspective view of a folding ladder of the present disclosure.

FIG. 2 is a perspective view of a top tread of the present disclosure.

FIG. 3 is an exploded view of the top tread of the present disclosure.

FIG. 4 is a cross-sectional view of a top tread in Embodiment 1 along line A-A in FIG. 2.

FIG. 5 is an enlarged view of area “a” in FIG. 4.

FIG. 6 is a cross-sectional view of a top tread in Embodiment 2 along line A-A in FIG. 2.

FIG. 7 is an enlarged view of area “a” in FIG. 6.

FIG. 8 is a cross-sectional view of a top tread in Embodiment 3 along line A-A in FIG. 2.

FIG. 9 is an enlarged view of area “a” in FIG. 8.

### DETAILED DESCRIPTION OF THE EMBODIMENTS

The following will clearly and completely describe the technical solutions in the embodiments of the present disclosure with reference to the accompanying drawings. Obviously, the described embodiments are only a portion of the embodiments of the present disclosure, and not all of the embodiments. Based on the embodiments of the present disclosure, all other embodiments obtained by those of ordinary skill in the art without creative work fall within the protection scope of the present disclosure.

In the description of the present disclosure, it should be noted that the terms “upper”, “lower”, “inner”, “outer”, “top end”, “bottom end”, etc. indicate the orientation or positional relationship based on the orientation shown in the drawings. The positional relationship is only for the convenience of describing the present disclosure and simplifying the description, rather than indicating or implying that the referenced device or element must have a specific orientation, be constructed, and be operated in a specific orientation. Therefore, the positional relationship should not be understood as a limitation of the present disclosure. In addition, the terms “first” and “second” are only used for descriptive purposes and should not be understood as indicating or implying relative importance.

In the description of the present disclosure, it should be noted that, unless otherwise explicitly specified and defined, terms such as “install”, “be provided with”, “be sleeved on”, “connected”, etc., should be understood broadly. For example, “connected” can be a fixed connection, a detachable connection, or an integral connection; it can be a mechanical connection or an electrical connection; it can be a direct connection or an indirect connection through an intermediary; it can be an internal communication between two components. For those of ordinary skill in the art, the specific meanings of the above terms in the present disclosure can be understood based on the specific context.

### Embodiment 1

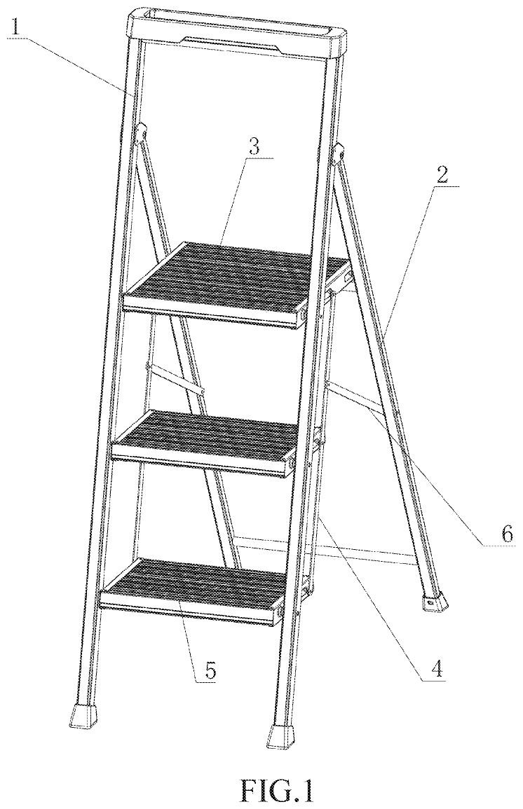

Referring to FIGS. 1-9, this embodiment provides a folding ladder, and the folding ladder comprises a front ladder frame 1 and a rear ladder frame 2. Two rods of the front ladder frame 1 are pivotally connected to two rods of the rear ladder frame 2. The folding ladder further comprises a top tread 3 and two sub-treads 5 arranged from top to bottom along a height direction. A width of the top tread 3 is greater than a width of each of the two sub-treads 5. A front end portion of the top tread 3 and front end portions of the two sub-treads 5 are respectively pivotally connected to the two rods of the front ladder frame 1. A rear end portion of the top tread 3 is pivotally connected to the two rods of the rear ladder frame 2. A middle portion of the top tread 3 and rear end portions of the two sub-treads 5 are pivotally connected to two side connecting rods 4. A pair of supporting rods 6 is provided. One end of each of the pair of supporting rods 6 is pivotally connected to a middle portion of a corresponding one of the two side connecting rods 4. The other end of each of the pair of supporting rods 6 is pivotally connected to a middle portion of a corresponding one of the two rods of the rear ladder frame 2. Through the aforementioned pivotal connection method, the folding ladder of this embodiment can achieve rotation at the connection points, thereby enabling folding.

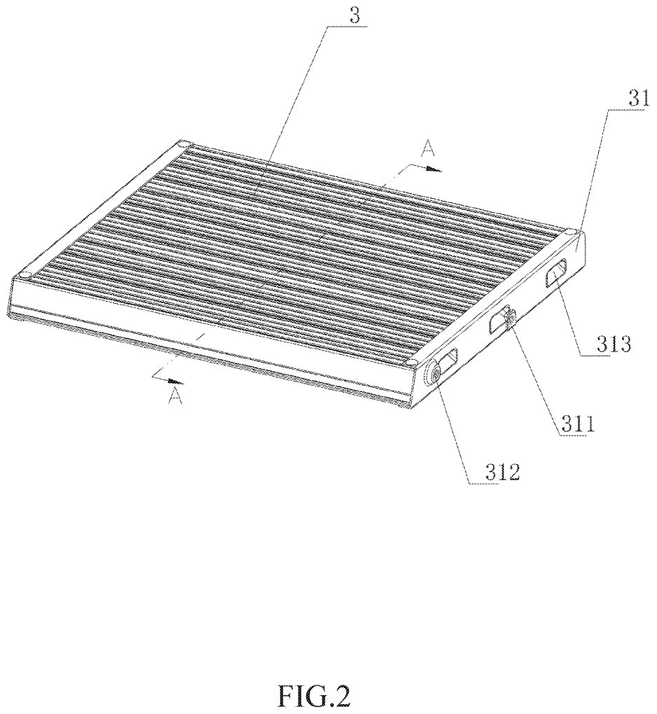

As shown in FIGS. 2-5, taking the top tread 3 as an example, the top tread 3 comprises three tread units 32, and each of the three tread units 32 comprises at least one of a tread unit A or a tread unit B. One end of a top surface of the tread unit A in a width direction of the top tread 3 extends downward for a specific distance along a thickness direction of the top tread 3 to form a first connection portion 321 to define a side of the tread unit A. A corresponding end of a top surface of the tread unit B in the width direction of the top tread 3 extends downward for a specific distance along the thickness direction of the top tread 3 to form a second connection portion 322 to define a side of the tread unit B. A bottom of the second connection portion 322 extends outward to form an extension portion 3224, and the extension portion 3224 is substantially parallel to a top surface of the top tread 3. The first connection portion 321 and the second connection portion 322 are substantially perpendicular to the top surface of the top tread 3.

The first connection portion 321 comprises two first riveting portions 3211 protruding in a thickness direction of the first connection portion 321 and spaced apart from each other in a length direction of the first connection portion 321, and the two first riveting portions 3211 are symmetrically arranged. The second connection portion 322 comprises two second riveting portions 3222 recessed in a thickness direction of the second connection portion 322 and spaced apart from each other in a length direction of the second connection portion 322, and the two first riveting portions 3211 correspond to the two second riveting portions 3222 in a one-to-one correspondence. The two first riveting portions 3211 and the two second riveting portions 3222 are connected by press riveting, causing the two first riveting portions 3211, which protrude from the first connection portion 321, to be pressed into the two second riveting portions 3222, which are recessed on the second connection portion 322, thereby achieving a fixed connection of the first connection portion 321 and the second connection portion 322. In this embodiment, since the two first riveting portion 3211 need to be pressed into the two second riveting portions 3222, panel materials of the three tread units 32 can be deformable, such as using ordinary low-carbon steel, aluminum, aluminum alloy, or other materials. The first connection portion 321 and the second connection portion 322 of two adjacent tread units 32 of the three tread units 32 are connected by press riveting, thereby splicing the three tread units 32 into the top tread 3.

To further increase supporting strength of the top tread 3, in this embodiment, a top of the second connection portion 322 is bent toward the first connection portion 321 of an adjacent one of the three tread units 32, thus forming a U-shaped hook 3221 extending downward. One of the three tread units 32 forms the first connection portion 321 downward while simultaneously extending upward to form a U-shaped limiting portion 3212 extending upward. The U-shaped limiting portion 3212 extends in an interior of the U-shaped hook 3221 to be interlocked with the U-shaped hook 3221. The bottom of the second connection portion 322 is bent toward the first connection portion 321 of the adjacent one of the three tread units 32 to form a U-shaped supporting seat 3223. A bottom end 3213 of the first connection portion 321 is inserted into the U-shaped supporting seat 3223 of the second connection portion 322, enabling the first connecting portion 321 to be supported.

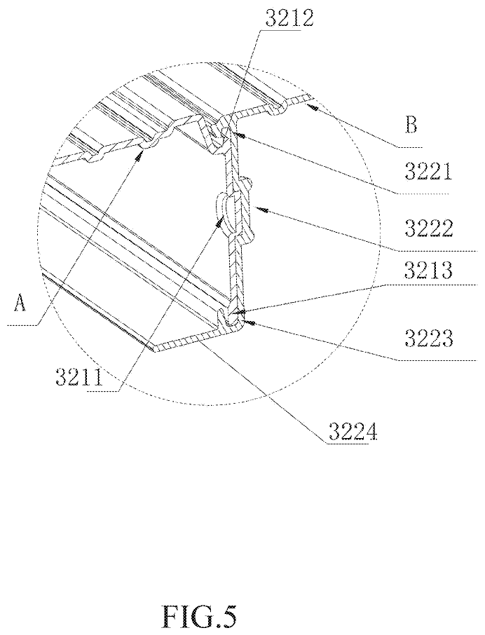

As shown in FIG. 5, each of the three tread units 32 comprises at least one of the tread unit A or the tread unit B. When the tread unit B is subjected to a force, the tread unit B can be hung on the U-shaped limiting portion 3212 of the tread unit A through the U-shaped hook 3221, thereby sharing a load. When the tread unit A is subjected to the force, the U-shaped supporting seat 3223 can support the tread unit A.

The two sub-treads 5 are also formed by splicing in the manner described above, and a number of tread units for each of the two sub-treads 5 can be 2.

To enable a connection of the top tread 3 and the two sub-treads 5 with the front ladder frame 1 and the two side connecting rods 4, taking the top tread 3 as an example, in this embodiment, the folding ladder further comprises two U-shaped packaging members 31 for packaging side edges of the spliced top tread 3. Each of the two U-shaped packaging members 31 comprises an upper edge portion 314 and a lower edge portion 315 opposite to each other, as well as a side packaging portion 316 connecting the upper edge portion 314 and the lower edge portion 315. The two U-shaped packaging members 31 are made of metal materials, which can be steel or aluminum.

Specifically, two ends of the upper edge portion 314 comprises riveting holes 3141. Top surfaces of corresponding ones of the three tread units 32 corresponding to the riveting holes 3141 on the upper edge portion 314 comprises riveting holes 323, and the riveting holes 3141 on the upper edge portion 314 are riveted to the riveting holes 323 on the top surfaces of the corresponding ones of the three tread units 32 through rivets. The bottom of the second connection portion 322 extends outward to form the extension portion 3224, and two ends of the extension portion 3224 in a length direction of the extension portion 3224 comprises riveting holes 32241, and the lower edge portion 315 comprises riveting holes 3151 corresponding to riveting holes 32241 of the extension portion 3224 in a one-to-one correspondence. The riveting holes 3151 of the lower edge portion 315 and the riveting holes 32241 of the extension portion 3224 are riveted together with rivets. By the aforementioned method, the two U-shaped packaging members 31 are respectively installed on two sides of the top tread.

A front end of each of the U-shaped packaging members 31 comprises a first pivoting member 312. The middle portion of the top tread 3 comprises a second pivoting member 311, and the rear end portion of the top tread 3 further comprises a third pivoting hole 313. The rear end portion of each of the two sub-treads 5 comprises the second pivoting member 311. The front end portion of the top tread 3 and the front end portions of the two sub-treads 5 are pivotally connected to a rod body of the front ladder frame 1 through the first pivoting member 312. The top tread 3 and the two sub-treads 5 are pivotally connected to the two side connecting rods 4 through the second pivoting member 311, thereby connecting the top tread 3 and the two sub-treads 5 to the rod body of the front ladder frame 1 and the two side connecting rods 4. The rear end portion of the top tread 3 is pivotally connected to the rear ladder frame 2 through the third pivoting hole 313.

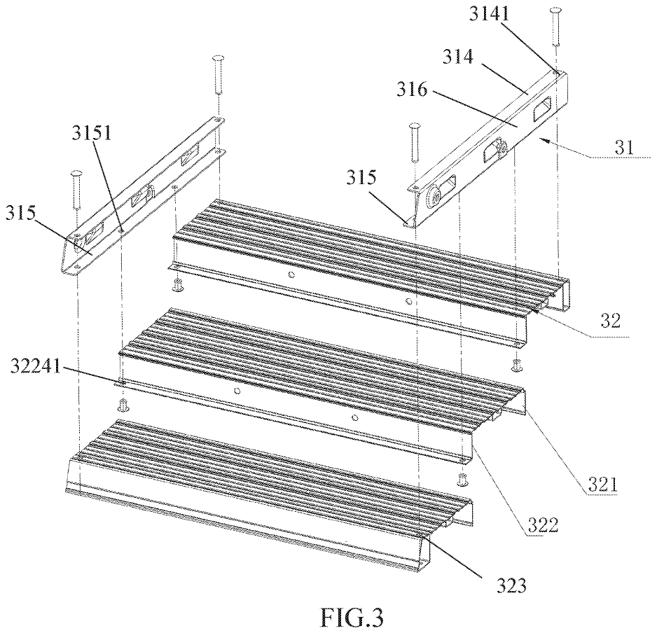

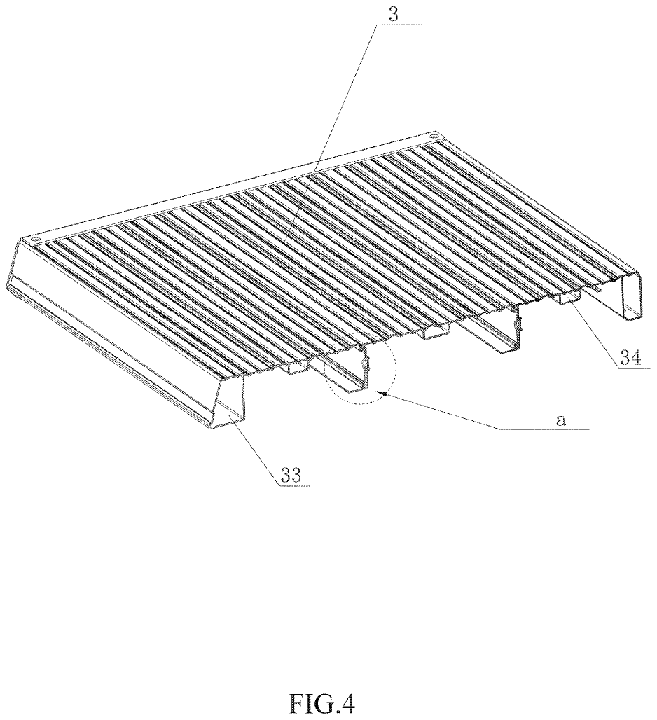

As shown in FIGS. 3 and 4, the tread unit A, or end tread unit, has a closed frame 33 on a side of the tread unit A away from a splicing end of the tread unit A. A depth of the closed frame 33 being equal to that of the first connection portion 321 and the second connection portion 322. A small closed frame 34 is provided approximately in a middle of each of the three tread units 32, which can enhance the supporting strength of the three tread units 32. The three tread units 32 are typically made of aluminum or plastic and produced through an extrusion process, as such a structure is easily achievable in extrusion manufacturing.

It should be noted that features related to quantities, such as a number of the sub-treads 5, a number of tread units 32 on the top tread 3 and the sub-treads 5, a number of first riveting portions 3211 and second riveting portions 3222, etc., are not limited to this embodiment.

### Embodiment 2

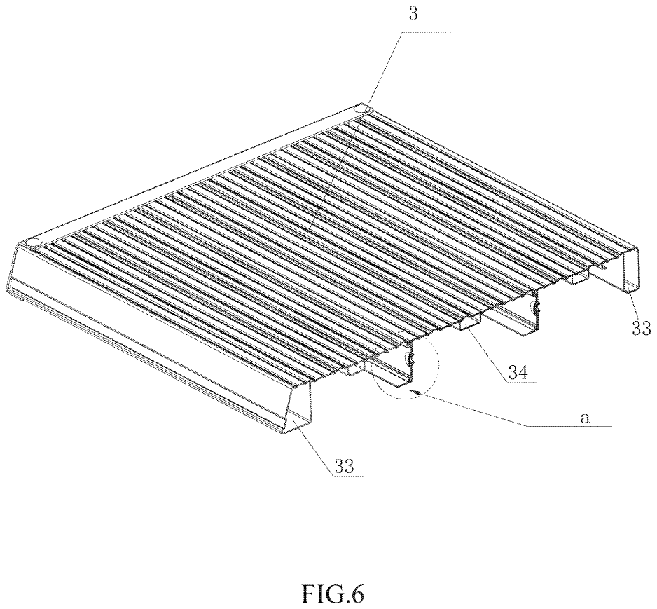

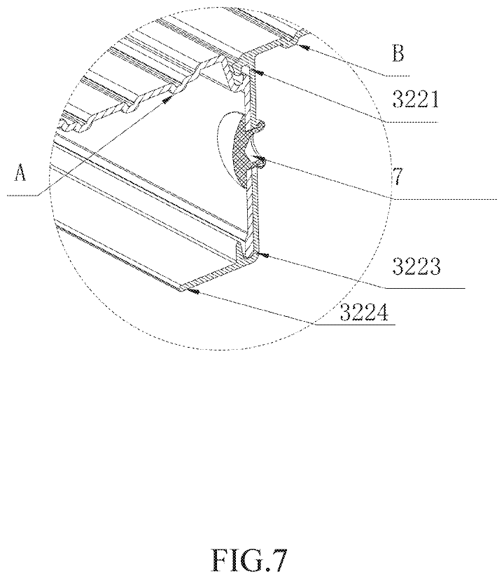

As shown in FIGS. 6-7, the difference between this embodiment and Embodiment 1 lies in the different riveting methods of the first connection portion 321 and the second connection portion 322 in this embodiment.

In this embodiment, the first connection portion 321 comprises at least two riveting holes symmetrically arranged in a length direction of the first connection portion 321, the second connection portion 322 comprises at least two riveting holes symmetrically arranged in a length direction of the second connection portion 322, and the at least two riveting holes of the first connection portion 321 and the at least two riveting holes of the second connection portion 322 are riveted together using rivets 7.

### Embodiment 3

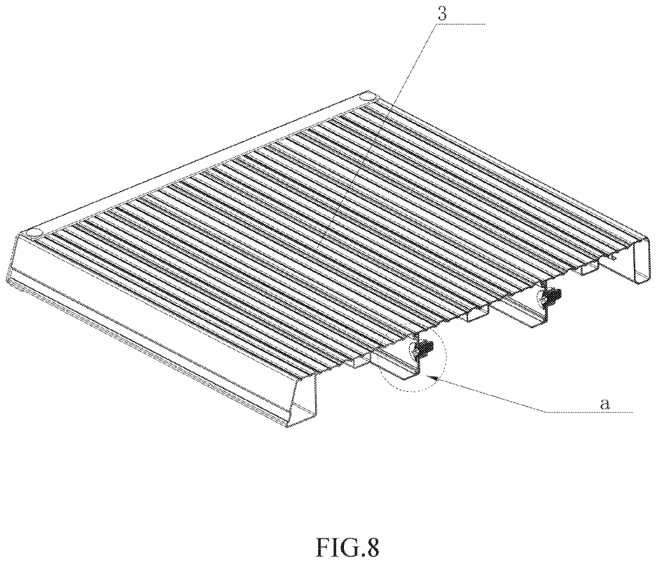

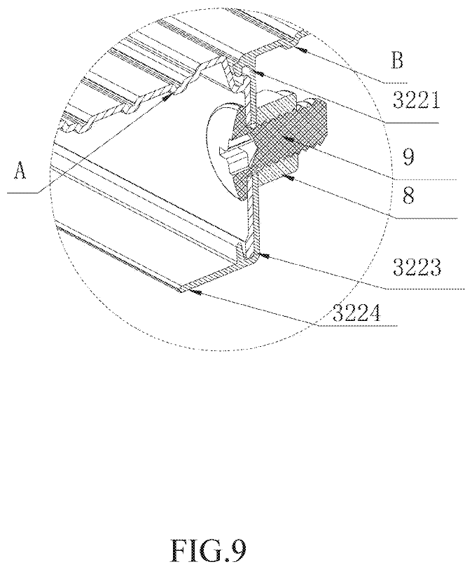

As shown in FIGS. 8-9, the difference between this embodiment and Embodiment 1 lies in the first connection portion 321 and the second connection portion 322 of this embodiment being connected through bolts and nuts. Specifically, the first connection portion 321 comprises at least two bolt holes symmetrically arranged in the length direction of the first connection portion 321, and the second connection portion 322 comprises at least two bolt holes symmetrically arranged in a length direction of the second connection portion 322. Bolts 9 pass through the at least two bolt holes of the first connection portion 321 and the at least two bolt holes of the second connection portion 322, and then nuts 8 are tightened to achieve the connection.

The aforementioned embodiments are merely some embodiments of the present disclosure, and the scope of the disclosure is not limited thereto. Thus, it is intended that the present disclosure cover non-substantive modifications of the present disclosure provided they are made based on the concept within the technical scope disclosed in the present disclosure by any technical person skilled in the art.

### INDUSTRIAL APPLICABILITY

The present disclosure provides a spliced tread for a ladder, comprising at least two tread units. A top surface of the at least two tread units extends along a thickness direction at one end in a width direction to form a first connection portion, and extends along the thickness direction at the other end to form a second connection portion. The first connection portion of one of the at least two tread units and the second connection portion of an adjacent one of the at least two tread units are connected to each other, so that the at least two tread units are spliced along the width direction to form the spliced tread for the ladder, which has industrial applicability.

What is claimed is:

1. A spliced tread for a ladder, comprising:
at least two tread units, wherein:
the at least two tread units comprises at least one of a first tread unit or a second tread unit,
one end of a top surface of the first tread unit in a width direction of the spliced tread extends in a thickness direction of the spliced tread to form a first connection portion to define a side of the first tread unit,
a corresponding end of the second tread unit extends in the thickness direction of the spliced tread to form a second connection portion to define a side of the second tread unit,
the first connection portion of the first tread unit and the second connection portion of the second tread unit are connected to each other, so that the at least two tread units are spliced in the width direction of the spliced tread to form the spliced tread for the ladder, and
one of:
the first connection portion comprises at least two first riveting portions protruding in a thickness direction of the first connection portion and spaced apart from each other in a length direction of the first connection portion, the second connection portion comprises at least two second riveting portions recessed in a thickness direction of the second connection portion and spaced apart from each other in a length direction of the second connection portion, and the at least two first riveting portions and the at least two second riveting portions are connected by pressure riveting,
the first connection portion comprises at least two riveting holes spaced apart from each other in the length direction of the first connection portion, the second connection portion comprises at least two riveting holes spaced apart from each other in the length direction of the second connection portion, and the at least two riveting holes of the first connection portion and the at least two riveting holes of the second connection portion are riveted together by rivets, or
the first connection portion comprises at least two bolt holes spaced apart from each other in the length direction of the first connection portion, the second connection portion comprises at least two bolt holes spaced apart from each other in the length direction of the second connection portion, and bolts are configured to pass through the at least two bolt holes of the first connection portion and the at least two bolt holes of the second connection portion to be connected to nuts.

2. The spliced tread of the ladder according to claim 1, wherein:
a top of the second connection portion is bent downward towards the first connection portion of an adjacent one of the at least two tread units to form a U-shaped hook,
the first connection portion extends upward to form a U-shaped limiting portion extending upward, and
the U-shaped limiting portion extends to an interior of the U-shaped hook to be interlocked with the U-shaped hook.

3. The spliced tread of the ladder according to claim 1, wherein:
a bottom of the second connection portion extends outward to form an extension portion,
the extension portion is substantially parallel to a top surface of the spliced tread,
the bottom of the second connection portion is bent upward to form a U-shaped supporting seat,
a bottom end of the first connection portion is disposed in the U-shaped supporting seat of the second connection portion, and
the U-shaped supporting seat limits movement of the bottom end of the first connection portion.

4. The spliced tread of the ladder according to claim 1, wherein:
sides of corresponding ones of the at least two tread units away from the first connection portion or the second connection portion define closed frames,
depths of the closed frames are equal to depths of the first connection portion and the second connection portion,
second closed frames are provided approximately in middle portions of the at least two tread units, and
the second closed frames have a depth that is smaller than the closed frames.

5. The spliced tread of the ladder according to claim 1, further comprising:
a U-shaped packaging member, wherein:
the U-shaped packaging member comprises an upper edge portion and a lower edge portion opposite to the upper edge portion, as well as a side packaging portion connecting the upper edge portion and the lower edge portion.

6. The spliced tread of the ladder according to claim 5, wherein:
two ends of the upper edge portion comprise riveting holes,
corresponding positions of top surfaces of the at least two tread units corresponding to the riveting holes on the upper edge portion comprises riveting holes, and
the riveting holes of the upper edge portion and the riveting holes on the top surfaces of the at least two tread units are riveted together with second rivets.

7. The spliced tread of the ladder according to claim 6, wherein:
a bottom of the second connection portion extends outward to form an extension portion,
two ends of the extension portion in a length direction of the extension portion comprise riveting holes,
the lower edge portion comprises riveting holes corresponding to riveting holes of the extension portion in a one-to-one correspondence, and
the riveting holes of the lower edge portion and the riveting holes of the extension portion are riveted together with third rivets.

8. A folding ladder, comprising:
a front ladder frame,
a rear ladder frame, and
a plurality of the spliced treads according to claim 1, wherein:
two rods of the front ladder frame are pivotally connected to two rods of the rear ladder frame, and
the plurality of the spliced treads are divided into a top tread and a plurality of sub-treads arranged sequentially along a height direction of the folding ladder.

9. The folding ladder according to claim 8, wherein:
a number of the at least two tread units of the top tread is greater than a number of the at least two tread units of the plurality of sub-treads,
front ends of U-shaped packaging members of the plurality of the spliced treads comprises a first pivoting member, and
front ends of the top tread and the plurality of sub-treads are pivotally connected to the two rods of the front ladder frame through the first pivoting member.

10. The folding ladder according to claim 9, wherein:
a middle portion of the top tread comprises a second pivoting member,
rear end portions of the plurality of sub-treads comprise additional second pivoting members,
a side connecting rod is provided,
the top tread is pivotally connected to the side connecting rod through the second pivoting member, and
the plurality of sub-treads are pivotally connected to the side connecting rod through the additional second pivoting members.

11. The folding ladder according to claim 10, further comprising:
a supporting rod, wherein:
one end of the supporting rod is pivotally connected to a middle portion of the side connecting rod, and
a second end of the supporting rod is pivotally connected to a corresponding one of the two rods of the rear ladder frame.

12. The spliced tread of the ladder according to claim 2, wherein:
a bottom of the second connection portion extends outward to form an extension portion,
the extension portion is substantially parallel to a top surface of the spliced tread,
the bottom of the second connection portion is bent upward to form a U-shaped supporting seat,
a bottom end of the first connection portion is disposed in the U-shaped supporting seat of the second connection portion, and
the U-shaped supporting seat limits movement of the bottom end of the first connection portion.

13. The spliced tread of the ladder according to claim 2, further comprising:
a U-shaped packaging member, wherein:
the U-shaped packaging member comprises an upper edge portion and a lower edge portion opposite to the upper edge portion, as well as a side packaging portion connecting the upper edge portion and the lower edge portion.

14. The spliced tread of the ladder according to claim 3, further comprising:
a U-shaped packaging member, wherein:
the U-shaped packaging member comprises an upper edge portion and a lower edge portion opposite to the upper edge portion, as well as a side packaging portion connecting the upper edge portion and the lower edge portion.

15. The spliced tread of the ladder according to claim 4, further comprising:
a U-shaped packaging member, wherein:
the U-shaped packaging member comprises an upper edge portion and a lower edge portion opposite to the upper edge portion, as well as a side packaging portion connecting the upper edge portion and the lower edge portion.

16. A folding ladder, comprising:
a front ladder frame,
a rear ladder frame, and
a plurality of the spliced treads according to claim 2, wherein:
two rods of the front ladder frame are pivotally connected to two rods of the rear ladder frame, and
the plurality of the spliced treads are divided into a top tread and a plurality of sub-treads arranged sequentially along a height direction of the folding ladder.

17. A folding ladder, comprising:
a front ladder frame,
a rear ladder frame, and
a plurality of the spliced treads according to claim 3, wherein:
two rods of the front ladder frame are pivotally connected to two rods of the rear ladder frame, and
the plurality of the spliced treads are divided into a top tread and a plurality of sub-treads arranged sequentially along a height direction of the folding ladder.

18. A folding ladder, comprising:
a front ladder frame,
a rear ladder frame, and
a plurality of the spliced treads according to claim 4, wherein:
two rods of the front ladder frame are pivotally connected to two rods of the rear ladder frame, and
the plurality of the spliced treads are divided into a top tread and a plurality of sub-treads arranged sequentially along a height direction of the folding ladder.

19. A folding ladder, comprising:
a front ladder frame,
a rear ladder frame, and
a plurality of the spliced treads according to claim 5, wherein:
two rods of the front ladder frame are pivotally connected to two rods of the rear ladder frame, and
the plurality of the spliced treads are divided into a top tread and a plurality of sub-treads arranged sequentially along a height direction of the folding ladder.

20. A folding ladder, comprising:
a front ladder frame,
a rear ladder frame, and
a plurality of the spliced treads according to claim 6, wherein:
two rods of the front ladder frame are pivotally connected to two rods of the rear ladder frame, and
the plurality of the spliced treads are divided into a top tread and a plurality of sub-treads arranged sequentially along a height direction of the folding ladder.
